(19) United States
(12) Patent Application Publication
(10) Pub. No.: US 2012/0256493 A1
(43) Pub. Date: Oct. 11, 2012

(54) SWITCHING DEVICE AND SWITCHING MODULE

(75) Inventor: Kenji SAITO, Tokyo (JP)

(73) Assignee: MITSUBISHI ELECTRIC CORPORATION, Chiyoda-ku (JP)

(21) Appl. No.: 13/293,721

(22) Filed: Nov. 10, 2011

(30) Foreign Application Priority Data
Apr. 7, 2011 (JP) 2011-085336

(51) Int. Cl. G05F 3/02

(52) U.S. Cl. 307/98

(57) ABSTRACT

A switching device includes: a switching element; an emitter electrode; an emitter terminal for main wiring for connecting the emitter electrode to an external main wiring; a plurality of control emitter terminals interposed in a main current path between the emitter electrode and the emitter terminal for main wiring; and inductances each interposed in the main current path and placed between adjacent ones of the control emitter terminals.

### BACKGROUND OF THE INVENTION

1. Field of the Invention

The present invention relates to the circuit structures of a switching device and a switching module.

2. Description of the Background Art

A conventional switching device such as that shown in Japanese Patent Application Laid-Open No. 10-229671 (1998) includes one emitter terminal for switching control.

So, di/dt (dv/dt) during transition of switching between ON and OFF has been controlled in response to the magnitude of a gate-to-emitter voltage V_{GE}, or to the magnitude of a gate resistance R_{G} between an external gate and an external emitter.

In a conventional switching device incorporated in an inverter circuit, a high surge voltage is generated depending on di/dt of a current interrupted during transition to turn-off and the inductance of a main wiring. The breakdown of a switching element may be generated if the generated surge voltage exceeds the rated voltage of the element. The breakdown of a switching element may also be generated during transition to turn-on if a recovery surge voltage exceeds the rated voltage of the element.

In addition, increase of di/dt (dv/dt) during transition between turn-on and turn-off leads to increase of noises to be generated.

### SUMMARY OF THE INVENTION

It is an object of the present invention to provide a switching device and a switching module capable of reducing a surge voltage and noises to be generated.

The switching device of the present invention includes: a switching element with a control terminal and a current electrode; a current terminal for main wiring for connecting the current electrode to an external main wiring; a plurality of control current terminals interposed in a main current path between the current electrode and the current terminal for main wiring; and an inductance interposed in the main current path and placed between adjacent ones of the control current terminals.

The switching module of the present invention includes a plurality of the switching devices.

Switching is made to a control emitter terminal of appropriate characteristics to make di/dt (dv/dt) variable during transition of switching, thereby allowing reduction of a surge voltage and reduction of noises to be generated.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a circuit diagram of a switching device of a first preferred embodiment of the present invention;

FIG. 2 is a circuit diagram showing connection between the switching device and a driver circuit of the first preferred embodiment of the present invention; and

FIGS. 3 to 5 are each a circuit diagram of a switching device of a second preferred embodiment of the present invention.

### EMBODIMENT FOR CARRYING OUT THE INVENTION

### <A. First Preferred Embodiment>

### <A-1. Structure>

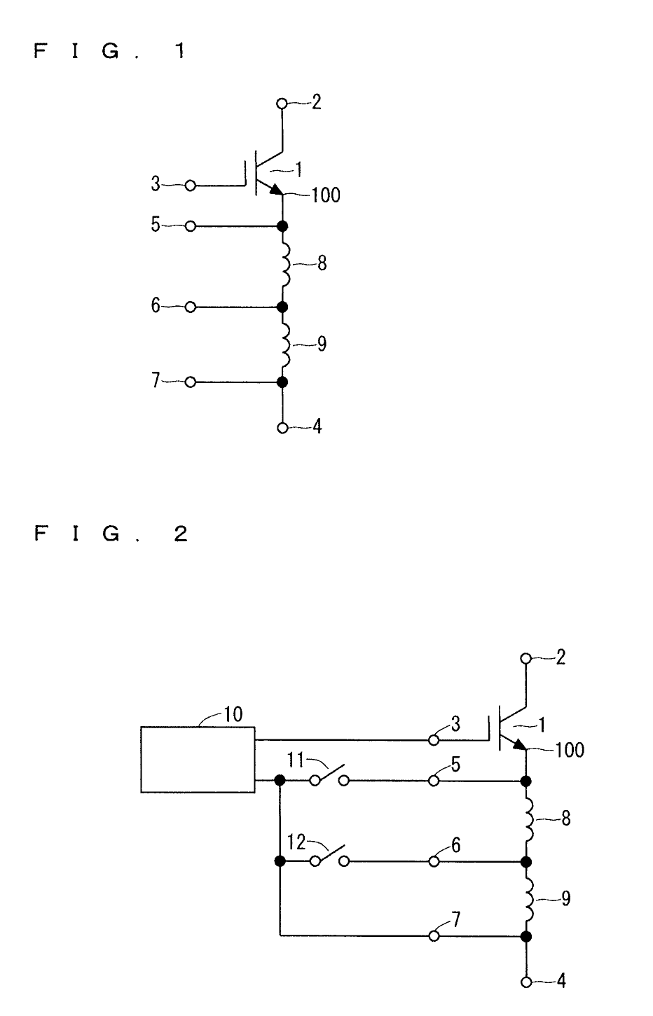

FIG. 1 is a circuit diagram of a switching device of the present invention. A switching element 1 shown in FIG. 1 is an IGBT, for example. The switching device includes the switching element 1, and a plurality of control emitter terminals 5, 6 and 7.

The control emitter terminals 5, 6 and 7 shown in FIG. 1 are connected to an internal wiring of the switching device such that the control emitter terminals 5, 6 and 7 have different inductances between the control emitter terminals 5, 6 and 7, and an emitter electrode 100 of the switching element 1. Different inductances 8 and 9 are connected inside the switching device.

More specifically, the switching element 1 includes a collector terminal 2, a gate terminal 3 as a control terminal, and the emitter electrode 100 as a current electrode. The switching element 1 further includes an emitter terminal 4 for main wiring as a current terminal for main wiring which is connected through the inductances 8 and 9 to the emitter electrode 100.

The emitter electrode 100, and the emitter terminal 4 for main wiring for connecting the emitter electrode 100 to a main wiring are connected through a path that functions as a main current path. The control emitter terminals 5, 6 and 7 are interposed as a plurality of control current terminals in the main current path.

The main current path also includes the inductance 8 placed between the control emitter terminals 5 and 6, and the inductance 9 placed between the control emitter terminals 6 and 7.

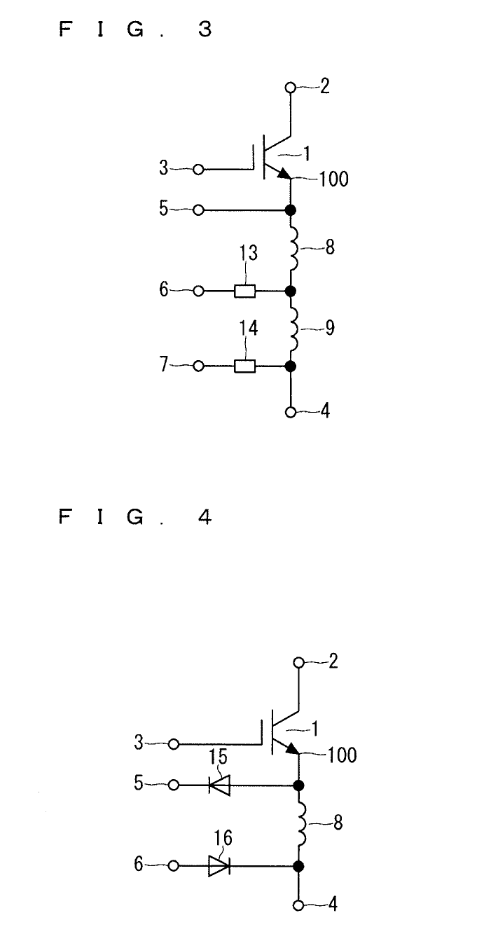

FIG. 2 is a circuit diagram showing exemplary connection between the switching device and a driver circuit.

As shown in FIG. 2, the gate terminal 3 of the switching element 1 is connected to a driver circuit 10. The control emitter terminals 5 and 6 are connected through changeover switches 11 and 12 respectively to the driver circuit 10. The changeover switches may be placed at any places in the path where the control emitter terminals are provided.

The driver circuit 10 controls a voltage relating to the switching element 1 through the gate terminal 3 to drive the switching element 1. The changeover switches 11 and 12 can be realized by using semiconductor switches. A control function of the changeover switches 11 and 12 may be realized by the driver circuit 10, or by a control circuit not shown. FIG. 2 does not show control signal lines relating to the changeover switches. The control emitter terminal 7 is also connected to the driver circuit 10.

Voltages are generated in the inductances 8 and 9 between the emitter terminal 4 for main wiring and the control emitter terminals when a current flowing in the main current path changes with time. It is a generally known fact that the generated voltages achieve the effect of negative feedback.

The present invention properly uses the plurality of control emitter terminals 5, 6 and 7 having different inductances to make the effect of negative feedback variable during transition of switching. This is also achieved in a switching device with the aforementioned switching element, in a switching module with a plurality of the switching elements, and others.

The changeover switches 11 and 12 of FIG. 2 make selection as to which of the control emitter terminals 5, 6 and 7 is to be used for general current interruption, or for interruption of excessive current for protection from an overcurrent or a short-circuit, thereby allowing reduction of a surge voltage and reduction of noises to be generated.

### <A-2. Effect>

The switching device of the first preferred embodiment of the present invention includes: the switching element with a control terminal and a current electrode; the emitter electrode 100 as the current electrode; the emitter terminal 4 for main wiring functioning as a current terminal for main wiring for connecting the emitter electrode 100 to an external main wiring; the control emitter terminals 5, 6 and 7 as a plurality of control current terminals interposed in a main current path between the emitter electrode 100 and the emitter terminal 4 for main wiring; and the inductances 8 and 9 each interposed in the main current path and placed between adjacent ones of the control emitter terminals 5, 6 and 7. This allows switching to a control emitter terminal of appropriate characteristics to make di/dt (dv/dt) variable during transition of switching, thereby allowing reduction of a surge voltage and reduction of noises to be generated.

The switching device of the first preferred embodiment of the present invention further includes: the driver circuit 10 for driving the switching element, and which is connected to the gate terminal 3 as a control terminal of the switching element and to the control emitter terminals 5, 6 and 7 as a plurality of control current terminals; and the changeover switches 11 and 12 interposed between the driver circuit 10 and at least one of the control emitter terminals 5, 6 and 7. This allows switching to a control emitter terminal of appropriate characteristics to make di/dt (dv/dt) variable during transition of switching.

In the switching device of the first preferred embodiment of the present invention, switching of the changeover switches 11 and 12 changes the inductance of the main current path. This allows suitable change of the inductance to make di/dt (dv/dt) variable during transition of switching.

The switching module of the first preferred embodiment of the present invention includes a plurality of the aforementioned switching devices. This allows reduction of a surge voltage and reduction of noises to be generated in the module.

### <B. Second Preferred Embodiment>

### <B-1. Structure>

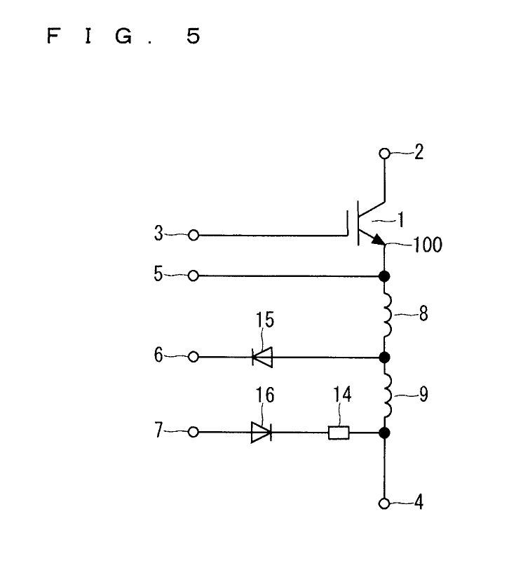

As shown in FIG. 3, limiting resistors 13 and 14 are provided between the control emitter terminal 6 and the main current path, and between the control emitter terminal 7 and the main current path. These limiting resistors function to limit a gate current to flow into the gate terminal 3 or flow out of the gate terminal 3, and which may be provided between any one of the control emitter terminals and the main current path. The limiting resistors are also applicable to the structure shown in FIG. 2.

Provision of the limiting resistors 13 and 14 achieves not only the effect of making di/dt (dv/dt) variable by negative feedback but also the effect of the limiting resistors themselves. More specifically, the gate terminal 3 is charged or discharged at a speed controlled by adjusting the value of a current (gate current) flowing into or flowing out of the gate terminal 3. The gate current is increased if a resistance value is small, charging or discharging the gate terminal 3 at a higher speed. In this case, di/dt (dv/dt) during transition between turn-on and turn-off of the element is increased. Meanwhile, the gate current is reduced if a resistance value is large, charging or discharging the gate terminal 3 at a lower speed. In this case, di/dt (dv/dt) during transition between turn-on and turn-off of the element is reduced.

Or, as shown in FIG. 4, diodes 15 and 16 for making switching between the control emitter terminals may be provided between the control emitter terminal 5 and the main current path, and between the control emitter terminal 6 and the main current path. The diodes may be provided between any one of the control emitter terminals and the main current path.

Provision of the diodes 15 and 16 allows switching between the control emitter terminals for each turn-on and turn-off without intervention of the external changeover switches 11 and 12 when a driver circuit such as that shown in FIG. 2 is connected.

The limiting resistor 14, and the diodes 15 and 16 may be used in combination as shown in FIG. 5.

Two or three control emitter terminals are used in each of the first and second preferred embodiments. The number of control emitter terminals may be changed where appropriate. The numbers of limiting resistors and diodes, and the locations of the limiting resistors and the diodes may also be changed where appropriate.

The IGBT element is used as an example in the description of the present invention. However, the present invention is applicable to elements such as an FET element driven by a gate voltage. If an FET element is used, the emitter electrode, the emitter terminal for main wiring, and the control emitter terminals are replaced by a source electrode, a source terminal for main wiring, and control source terminals respectively.

The present invention is applicable not only to the use of an Si element but also to the use of an SiC element. A switching element made of SiC generally operates at a higher speed than an Si element, so it tends to increase a surge voltage and noises to be generated during transition of switching. Thus, reduction of a surge voltage and reduction of noises to be generated achieved by the present invention are particularly effective in the use of a switching element made of SiC.

The present invention is applicable to a module such as an IPM (intelligent power module) on which a plurality of elements is placed.

### <B-2. Effect>

The switching device of the second preferred embodiment of the present invention further includes the diodes 15 and 16 between at least one of the control emitter terminals 5, 6 and 7 as a plurality of control current terminals and the main current path. So, di/dt (dv/dt) can be made variable by negative feedback during transition of switching to turn-on or turn-off, thereby allowing reduction of a surge voltage and reduction of noises to be generated.

The switching device of the second preferred embodiment of the present invention further includes the limiting resistors 13 and 14 between at least one of the control emitter terminals 5, 6 and 7 as a plurality of control current terminals and the main current path. So, di/dt (dv/dt) can be made variable by the resistors, thereby allowing reduction of a surge voltage and reduction of noises to be generated.

While the invention has been shown and described in detail, the foregoing description is in all aspects illustrative and not restrictive. It is therefore understood that numerous modifications and variations can be devised without departing from the scope of the invention.

What is claimed is:

1. A switching device, comprising:
a switching element with a control terminal and a current electrode;
a current terminal for main wiring for connecting said current electrode to an external main wiring;
a plurality of control current terminals interposed in a main current path between said current electrode and said current terminal for main wiring; and
an inductance interposed in said main current path and placed between adjacent ones of said control current terminals.

2. The switching device according to claim 1, further comprising a diode provided between at least one of said control current terminals and said main current path.

3. The switching device according to claim 1, further comprising a limiting resistor provided between at least one of said control current terminals and said main current path.

4. The switching device according to claim 1, further comprising:
a driver circuit for driving said switching element, the driver circuit being connected to said control terminal and said control current terminals; and
a changeover switch interposed between said driver circuit and at least one of said control current terminals.

5. The switching device according to claim 4, wherein switching of said changeover switch changes the inductance of said main current path.

6. The switching device according to claim 1, wherein said switching element is an SiC element.

7. A switching module comprising a plurality of the switching devices as recited in claim 1.
